(19) United States
(12) Patent Application Publication
(10) Pub. No.: US 2025/0307634 A1
(43) Pub. Date: Oct. 2, 2025

(54) SUPPORT METHOD, SUPPORT DEVICE, AND RECORDING MEDIUM

(71) Applicant: Panasonic Automotive Systems Co., Ltd., Kanagawa (JP)

(72) Inventors: Mizuki NEMOTO, Osaka (JP); Shogo SAKUMA, Osaka (JP)

(73) Assignee: Panasonic Automotive Systems Co., Ltd., Kanagawa (JP)

(21) Appl. No.: 19/085,567

(22) Filed: Mar. 20, 2025

(30) Foreign Application Priority Data
Mar. 29, 2024 (JP) 2024-055974

(51) Int. Cl. G06N 3/082; G06N 3/0464

(52) U.S. Cl. CPC G06N 3/082; G06N 3/0464

(57) ABSTRACT

A support method supports pruning of a learning model using a neural network including a depthwise convolutional layer and a subsequent convolutional layer subsequent to the depthwise convolutional layer. The learning model includes a target neuron to be pruned in the depthwise convolutional layer. The support method includes: determining whether the depthwise convolutional layer has a bias term; obtaining a bias value based on the bias term, when the depthwise convolutional layer has the bias term; and calculating a correction value for correcting a bias term of the subsequent convolutional layer, using a value based on the bias value.

### CROSS REFERENCE TO RELATED APPLICATION

The present application is based on and claims priority of Japanese Patent Application No. 2024-055974 filed on Mar. 29, 2024.

### FIELD

The present disclosure relates to a support method, support device, and recording medium for supporting pruning of a learning model using a neural network including a depthwise convolutional layer and a convolutional layer subsequent to the depthwise convolutional layer.

### BACKGROUND

Known methods for making a learning model more lightweight include pruning, quantization, and distillation. Patent Literature (PTL) 1 discloses a technology that makes a learning model more lightweight by quantization.

### CITATION LIST

### Patent Literature

PTL 1: Japanese Unexamined Patent Application Publication No. 2022-49997

### SUMMARY

However, the technology according to PTL 1 can be improved upon.

In view of this, the present disclosure provides a support method, support device, and recording medium capable of improving upon the above related art.

A support method according to one aspect of the present disclosure is a support method of supporting pruning of a learning model using a neural network including a first depthwise convolutional layer and a subsequent convolutional layer subsequent to the first depthwise convolutional layer, the learning model including a target neuron to be pruned in the first depthwise convolutional layer, the support method including: determining whether the first depthwise convolutional layer has a bias term; obtaining a first bias value based on the bias term, when the first depthwise convolutional layer has the bias term; and calculating a correction value for correcting a bias term of the subsequent convolutional layer, using a value based on the first bias value.

A support device according to one aspect of the present disclosure is a support device that supports pruning of a learning model using a neural network including a depthwise convolutional layer and a subsequent convolutional layer subsequent to the depthwise convolutional layer, the learning model including a target neuron to be pruned in the depthwise convolutional layer, the support device including: a determiner that determines whether the depthwise convolutional layer has a bias term; an obtainer that obtains a bias value based on the bias term, when the depthwise convolutional layer has the bias term; and a calculator that calculates a correction value for correcting a bias term of the subsequent convolutional layer, using a value based on the bias value.

A recording medium according to one aspect of the present disclosure is a non-transitory computer-readable recording medium having recorded thereon a program for causing a computer to execute the above-described support method.

A support method, etc. according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating the functional structure of a support device according to Embodiment 1.

FIG. 2 is a flowchart illustrating the operation of the support device according to Embodiment 1.

FIG. 3 is a diagram for explaining pruning and bias term correction in the support device according to Embodiment 1.

FIG. 4 is a diagram for explaining the effects of the support device according to Embodiment 1.

FIG. 5 is a flowchart illustrating the operation of a support device according to Embodiment 2.

### DESCRIPTION OF EMBODIMENTS

### Circumstances Leading to the Present Disclosure

Pruning is sometimes used as a technology of making a learning model more lightweight. The amount of pruning needs to be increased in order to enhance the compressibility of the learning model. Increasing the amount of pruning, however, may cause degradation in the accuracy of the learning model. Thus, conventionally there is a trade-off relationship between compressibility and accuracy, and it is difficult to compress the learning model without accuracy degradation.

In view of this, the inventors of the present application have carefully studied, as a further improvement, a support method, etc. that, when pruning a learning model, can compress the learning model without accuracy degradation, and discovered the following support device, etc.

Certain exemplary embodiments will be described in detail below with reference to the drawings.

Each of the embodiments described below shows a general or specific example. The numerical values, shapes, structural elements, the arrangement and connection of the structural elements, steps, the processing order of the steps etc. illustrated in the following embodiments are mere examples, and do not limit the scope of the present disclosure. Of the structural elements in the embodiments described below, the structural elements not recited in any one of the independent claims will be described as optional structural elements.

Each drawing is a schematic and does not necessarily provide precise depiction. For example, scale and the like are not necessarily consistent throughout the drawings. The substantially same elements are given the same reference marks throughout the drawings, and repeated description is omitted or simplified.

In the specification, the terms indicating the relationships between elements, such as “same” and “equal”, the numerical values, and the numerical ranges are not expressions of strict meanings only, but are expressions of meanings including substantially equivalent ranges, for example, allowing for a difference of about several percent (or about 10%). In this specification, ordinal numbers such as “first” and “second” do not mean the numbers or order of structural elements unless otherwise specified, but are used for the purpose of avoiding confusion and distinguishing between structural elements of the same type.

### Embodiment 1

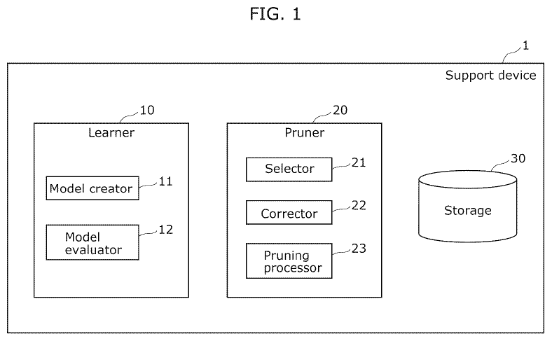

A support device, etc. according to this embodiment will be described below with reference to FIGS. 1 to 4.

### 1. Structure of Support Device

First, the structure of the support device according to this embodiment will be described with reference to FIG. 1. FIG. 1 is a block diagram illustrating the functional structure of support device 1 according to this embodiment.

Support device 1 is an information processing device that supports pruning of a learning model (deep learning model) using a convolutional neural network (CNN) including a depthwise convolutional layer and a convolutional layer subsequent to the depthwise convolutional layer. In this embodiment, the subsequent convolutional layer is a layer immediately following the depthwise convolutional layer. Each of the depthwise convolutional layer and the subsequent convolutional layer includes a plurality of neurons, and each of the plurality of neurons included in the depthwise convolutional layer is connected (coupled) to a corresponding neuron included in the subsequent convolutional layer. Each layer in a neural network typically has an activation function such as a ReLU function, an identity function, or a sigmoid function. While it is assumed here that each layer in the neural network according to this embodiment has an activation function, the activation function is basically omitted and is specified when necessary in the description of this embodiment. Although this embodiment describes an example in which the subsequent convolutional layer is a pointwise convolutional layer, the subsequent convolutional layer may be a layer (for example, a normal convolutional layer) different from a depthwise convolutional layer and a pointwise convolutional layer. Each layer in the neural network is not limited to having an activation function. Each layer in the neural network may have, for example, an identity function.

Depthwise convolutional layers and pointwise convolutional layers are layers included in convolutional neural networks such as MobileNetV1. While normal convolutional layers simultaneously perform convolution in the spatial direction and the channel direction, depthwise convolutional layers only perform convolution in the spatial direction and pointwise convolutional layers only perform convolution in the channel direction. Hereafter, the “depthwise convolutional layer” is also referred to as “DW convolutional layer” or “DW”, and the “pointwise convolutional layer” is also referred to as “PW convolutional layer” or “PW”.

The learning model is, for example, a machine learning model for image recognition or voice recognition, but is not limited to such applications. Hereafter, the “convolutional neural network” is also simply referred to as “neural network”.

As illustrated in FIG. 1, support device 1 includes learner 10, pruner 20, and storage 30 as functional components. Support device 1 is implemented by non-volatile memory in which a program is stored, volatile memory as a temporary storage area for executing the program, input/output ports, a communication interface, a processor for executing the program, and so on. Support device 1 may be implemented by a stationary personal computer (PC), a portable PC, a mobile terminal such as a smartphone or a tablet, a dedicated computer, or a server (e.g. a cloud server).

Learner 10 is a processing unit that performs a learning process to create a desired learning model. Learner 10 determines each parameter (e.g. the below-described biases and weights) of the machine learning model by performing the learning process. A bias (bias term) is one of the important parameters in a neural network, and is a constant that is added to the output of each neuron and is a fixed value regardless of the input to the neuron. A weight is a constant that indicates the strength of the connection between neurons. Learner 10 includes model creator 11 and model evaluator 12.

Model creator 11 creates a learning model by executing a learning process for a machine learning model using a learning data set including image data for learning and correct answer data. The learning model is a machine learning model using a neural network including at least a DW convolutional layer. In this embodiment, the learning model is a machine learning model using a neural network including a DW convolutional layer and a PW convolutional layer subsequent to the DW convolutional layer. Model creator 11 causes learning of optimal parameters in each layer of the learning model by a known method such as backpropagation. The method of creating the learning model by model creator 11 is not limited to backpropagation, and may be any known method.

Model evaluator 12 evaluates the learning model created by model creator 11 using an evaluation data set including image data for evaluation and correct answer data. Model evaluator 12 inputs the image data for evaluation to the learning model to obtain a label corresponding to the image data as output of the learning model, and evaluates the learning model based on the label and the correct answer data. The evaluation data set may include at least part of the data in the learning data set, or include data different from the learning data set.

Thus, whether the learning model created by model creator 11 has performance higher than or equal to a predetermined level can be determined. If the performance of the learning model is lower than the predetermined level, model creator 11 may perform relearning of the created learning model.

Pruner 20 is a processing unit that performs a pruning process to make the learning model created by learner 10 more lightweight. Neurons are connected to neurons in the next layer, and pruning includes deleting (cutting off) paths (weights) between weakly connected neurons. For example, pruning may be a process for stopping the transfer of data between neurons that transfer data in one direction (i.e. a process for disconnection). Moreover, pruning may include deleting neurons whose output (channel) is zero or close to zero. Hereafter, expressions such as “deleting a neuron” mean not only deleting the neuron but also deleting each path to which the neuron is connected and its weight. Pruning can reduce the amount of calculation and memory usage. Pruner 20 includes selector 21, corrector 22, and pruning processor 23.

Selector 21 selects a target neuron to be pruned from the plurality of neurons included in the learning model created by learner 10. The method of selecting the target neuron by selector 21 is not limited, and a method using the APOZ (average percentage of zeros) index may be used, for example. The APOZ index is an index for determining the deletion of a neuron in a neural network. For example, the percentage of zero activation output (output that is almost or completely zero) is calculated, and the target neuron to be pruned is selected so as to delete a neuron with a high percentage of zero activation. Selector 21 may create a target neuron list which is a list of target neurons to be pruned, and store the target neuron list in storage 30 in association with the learning model.

Corrector 22, when the target neuron selected by selector 21 is connected to a neuron in a DW convolutional layer having a bias term, corrects a bias term of a PW convolutional layer subsequent to the DW convolutional layer according to the bias term of the DW convolutional layer. The target neuron is a neuron in a convolutional layer preceding the DW convolutional layer.

Corrector 22 calculates a correction value based on the term of the DW convolutional layer connected to the target neuron to be pruned and a weight of the PW convolutional layer subsequent to the DW convolutional layer connected to the target neuron, and corrects the bias term of the subsequent PW convolutional layer (e.g. the bias term of the neuron connected to the target neuron among the plurality of neurons included in the subsequent PW convolutional layer) based on the calculated correction value.

Pruning processor 23 deletes the target neuron selected by selector 21, and stores the learning model from which the target neuron has been deleted in storage 30. For example, pruning processor 23 performs pruning by deleting neurons with a high percentage of zero activation selected by selector 21 from the network and simultaneously removing the connections between neurons. The learning model stored in storage 30 by pruning processor 23 is a learning model obtained by correcting the bias term of the subsequent convolutional layer and also deleting the target neuron in the learning model created by learner 10.

Storage 30 is a storage device that stores various information used in the pruning process, the learning model after the pruning process, etc. Storage 30 stores, for example, the learning model created by learner 10 (i.e. the learning model before the pruning process), the learning model after the pruning process by pruner 20, and information about the learning model. The information about the learning model includes information indicating the structure of the neural network in the learning model created by learner 10, information used in the convolution process, etc. The information indicating the structure of the neural network includes information indicating, for each layer, which of a DW convolutional layer, a PW convolutional layer, and any other convolutional layer the layer is, whether a bias term is provided in the layer, etc. The information indicating the structure of the neural network may also include information about the activation function of each layer in the neural network. The information used in the convolution process includes a kernel size, etc. Storage 30 may also store various data sets. As a non-limiting example, storage 30 is implemented by semiconductor memory.

Support device 1 may include no learner 10. Support device 1 may obtain a learning model created by an external device through communication or the like, and support pruning of the obtained learning model. Thus, support device 1 includes at least pruner 20.

### 2. Operation of Support Device

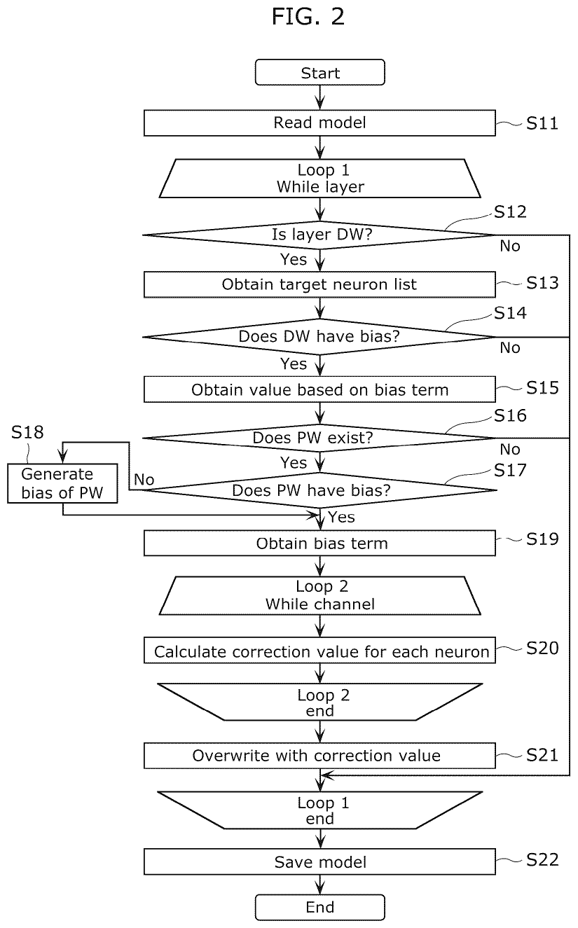

Next, the operation of support device 1 having the above-described structure will be described with reference to FIGS. 2 to 4. FIG. 2 is a flowchart illustrating the operation (support method) of support device 1 according to this embodiment. Each operation illustrated in FIG. 2 is executed by corrector 22.

As illustrated in FIG. 2, corrector 22 first reads a model (learning model) from storage 30 (S11). For example, corrector 22 obtains the learning model created by learner 10 by reading it from storage 30. Corrector 22 then executes the process of Steps S12 to S21 for each layer (loop 1). Corrector 22 functions as an obtainer.

Next, corrector 22 determines whether the layer is a DW convolutional layer (DW) based on information about the learning model (S12). Corrector 22 functions as a determiner.

When corrector 22 determines that the layer is a DW convolutional layer (S12: Yes), corrector 22 obtains a target neuron list (S13). Corrector 22 may read the target neuron list from storage 30, for example.

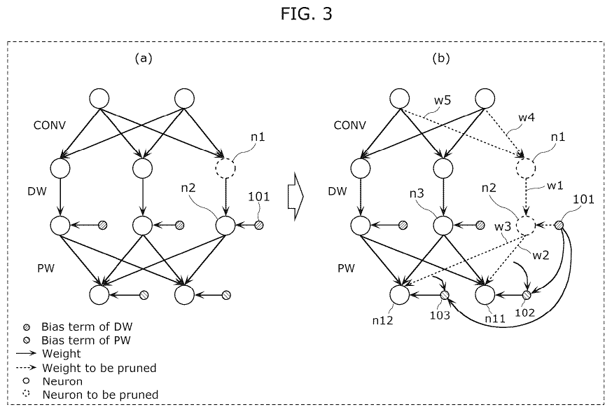

Here, the details of the problem to be solved in the present disclosure, pruning, etc. will be described with reference to FIG. 3. FIG. 3 is a diagram for explaining pruning and bias term correction in support device 1 according to this embodiment. In FIG. 3, white circles represent neurons, dashed circles represent target neurons to be pruned, diagonally hatched circles represent bias terms in a DW convolutional layer or a PW convolutional layer, solid arrows represent weights, and dashed arrows represent weights connected to target neurons to be pruned.
(a) in FIG. 3 illustrates an example in which neuron n1 in a normal convolutional layer (CONV) is selected as a target neuron to be pruned. For example, the output of neuron n1 is zero. In this case, the input to neuron n2 is zero, but neuron n2 has bias term 101 and accordingly bias term 101 is output from neuron n2 to each neuron in a PW convolutional layer. It is assumed here that neuron n1 does not have a bias term. Bias term 101 is a bias term of a DW convolutional layer connected to the target neuron (neuron n1 in this example). Weights w2 and w3 are each a weight of the PW convolutional layer subsequent to the DW convolutional layer connected to the target neuron (neuron n1).

As illustrated in (b) in FIG. 3, since only the output from neuron n1 is input to neuron n2 in the DW convolutional layer (DW), if neuron n1 is pruned, neuron n2 is also selected as a target neuron to be pruned on the assumption that the output of neuron n2 is zero. (b) in FIG. 3 illustrates an example in which weight w1 connecting neurons n1 and n2, the weights (e.g. weights w2 and w3) connecting neuron n2 to the respective neurons in the PW convolutional layer, and the weights (e.g. weights w4 and w5) on the input side of neuron n1 are selected as target weights to be pruned. This selection is performed by selector 21. Bias term 101 is an example of a bias term of neuron n2.

As mentioned above, while neuron n2 has bias term 101, if neuron n2 is pruned, weights w2 and w3 are also pruned, and bias term 101 is no longer output from neuron n2 to neurons n11 and n12.

The following Formula 1 represents the output of neuron n2. O^{(DW)} denotes the output of a neuron in the DW convolutional layer, O^{(CONV)} denotes the output of a neuron in the normal convolutional layer preceding the DW convolutional layer, W^{(DW)} denotes the weight connecting the DW convolutional layer and the PW convolutional layer, and b^{(DW)} denotes the bias term of the neuron in the DW convolutional layer. The subscript i is a number that identifies a neuron in the convolutional layer, and pruned denotes a pruning target. f^{(DW)} denotes the activation function applied to the DW convolutional layer. “·” in the formula denotes multiplication (or convolution operation).

$$[ Math . 1 ]$$

$${O}_{{i}_{pruned}}^{( DW )} = {f}^{( DW )} ( {W}_{{i}_{pruned}}^{( DW )} \cdot {O}^{( CONV )} + {b}_{{i}_{pruned}}^{( DW )} ) = {f}^{( DW )} ( {b}_{{i}_{pruned}}^{( DW )} ) . \qquad ( Formula 1 )$$

As can be seen from Formula 1, even if O^{(CONV)} is zero, neuron n2 in the DW convolutional layer is supposed to output a value (hereafter also referred to as “bias value”) obtained by applying the activation function to the bias term. Applying the activation function means that the activation function is taken into account in the output of the neuron in the DW convolutional layer, for example, the bias term of the neuron in the DW convolutional layer is multiplied by the activation function.

If neuron n2 is to be pruned, however, the output from neuron n2 is zero, which differs from Formula 1. In other words, the value input to each neuron in the PW convolutional layer differs between before and after the pruning process. This leads to a decrease in the accuracy of the learning model. Here, bias terms and bias values are expressed as vectors.

The output of a neuron in the PW convolutional layer is expressed in the following Formulas 2 and 3. Formula 2 represents the value output from the neuron before pruning, and Formula 3 represents the value output from the neuron after pruning. O^{(PW)} denotes the value before the activation function is applied in the neuron of the PW convolutional layer, W^{(PW)} denotes the weight between the neuron in the DW convolutional layer and the neuron in the PW convolutional layer, and b^{(PW)} denotes the bias value of the neuron in the PW convolutional layer. The subscript j is a number that identifies a neuron in the convolutional layer, and pruned denotes a pruning target. Wⱼᵢ denotes the weight between the ith neuron in the DW convolutional layer and the jth neuron in the PW convolutional layer. Although the activation function applied to the PW convolutional layer is omitted for the sake of explanation of the formulas, the activation function is applied to O^{(PW)} in a typical PW convolutional layer.

$$[ Math . 2 ]$$

$${O}_{j}^{( PW )} = {W}_{{ji}_{pruned}}^{( PW )} \cdot {O}_{{i}_{pruned}}^{( DW )} + {b}_{j}^{( PW )} = {W}_{{ji}_{pruned}}^{( PW )} \cdot {f}^{( DW )} ( {b}_{{i}_{pruned}}^{( DW )} ) + {b}_{j}^{( PW )} . \qquad ( Formula 2 )$$

$$[ Math . 3 ]$$

$${O}_{j}^{( PW )} = {W}_{{ji}_{pruned}}^{( PW )} \cdot {O}_{{i}_{pruned}}^{( DW )} + {b}_{j}^{( PW )} = 0 + {b}_{j}^{( PW )} = {b}_{j}^{( PW )} . \qquad ( Formula 3 )$$

It can be seen from Formulas 2 and 3 that the error expressed in the following Formula 4 occurs.

$$[ Math . 4 ]$$

$${W}_{{ji}_{pruned}}^{( PW )} \cdot {f}^{( DW )} ( {b}_{{i}_{pruned}}^{( DW )} ) . \qquad ( Formula 4 )$$

This error corresponds to the multiplication (convolution operation) of bias term 101 of neuron n2 and the weight (weight w2 or w3) between neuron n2 and neuron n11 or n12. As a result of neuron n2 being pruned, the multiplication (convolution operation) of bias term 101 of neuron n2 and the weight between neuron n2 and neuron n11 or n12 is skipped. Here, weight w1 is the weight between neurons n2 and n11, and weight w2 is the weight between neurons n2 and n12.

Thus, if neuron n2 is a target neuron to be pruned, the bias value of neuron n2 is not input to each neuron (e.g. neurons n11 and n12) in the PW convolutional layer, so that the foregoing output error occurs. This is likely to cause a decrease in the accuracy of the learning model.

In view of this, in the present disclosure, the bias term of each neuron in the subsequent PW convolutional layer is corrected based on the bias term corresponding to the target neuron to be pruned.

Referring again to FIG. 2, corrector 22 then determines whether the DW convolutional layer has a bias (bias term) based on the information about the learning model (S14). Since DW convolutional layers include layers that have a bias and layers that do not have a bias, whether the DW convolutional layer is a layer that has a bias is determined in Step S14.

When corrector 22 determines that the DW convolutional layer has a bias (S14: Yes), corrector 22 obtains a value based on a bias term corresponding to a target neuron based on the target neuron list (S15). For example, corrector 22 obtains a bias value of the DW convolutional layer connected to the target neuron. If the DW convolutional layer has an identity function, the bias term corresponding to the target neuron (i.e. the bias term of the DW convolutional layer) is obtained as the value based on the bias term of the DW convolutional layer connected to the target neuron in Step S15.

Next, corrector 22 determines whether a PW convolutional layer exists subsequent to the DW convolutional layer based on the information about the learning model (S16). Corrector 22 determines whether the DW convolutional layer and the PW convolutional layer are arranged successively.

Since the subsequent convolutional layer is not limited to being a PW convolutional layer, the determination in Step S16 may be omitted.

When corrector 22 determines that a PW convolutional layer exists subsequent to the DW convolutional layer (S16: Yes), corrector 22 determines whether the PW convolutional layer has a bias based on the information about the learning model (S17).

When corrector 22 determines that the PW convolutional layer has a bias (S17: Yes), corrector 22 obtains the bias term of each of the plurality of neurons in the PW convolutional layer (S19). Corrector 22 obtains the bias term of the PW convolutional layer subsequent to the DW convolutional layer connected to the target neuron.

When corrector 22 determines that the PW convolutional layer does not have a bias (S17: No), corrector 22 generates a bias of the PW convolutional layer (S18). Corrector 22 generates a matrix with zero elements as the bias term of the PW convolutional layer. In other words, corrector 22 obtains the bias term of the PW convolutional layer by generating a matrix with zero elements (S19).

Next, corrector 22 calculates a correction value for each neuron in the PW convolutional layer, based on the value based on the bias term obtained in Step S15 (S20). Corrector 22 calculates a correction value for correcting the bias term of each neuron in the PW convolutional layer. Corrector 22 executes the process of Step S20 for each neuron (loop 2). Corrector 22 functions as a calculator.

Corrector 22 obtains the value calculated using Formula 4, as the correction value for the neuron in the PW convolutional layer.

In other words, corrector 22 calculates the above-described error as the correction value. Since Wⱼᵢ can be a different value for each neuron in the PW convolutional layer, the value expressed in Formula 4 (i.e. the correction value) is calculated individually for each neuron in the PW convolutional layer.

Referring again to FIG. 2, corrector 22 then overwrites the bias value of the bias term in the learning model learned by learner 10 with the correction value calculated in Step S20 (S21). The correction target here is the bias term of the PW convolutional layer. Corrector 22 individually corrects the bias term of each neuron in the PW convolutional layer based on the corresponding correction value calculated in Step S20. In other words, corrector 22 replaces the bias value of each neuron in the PW convolutional layer with a bias value corrected by the correction value. The corrected bias value is calculated, for example, using the following Formula 5.

$$[ Math . 5 ]$$

$$Corrected bias term ( {b}_{j}^{( )} ) = {b}_{j}^{( PW )} + {W}_{{ji}_{pruned}}^{( PW )} \cdot {f}^{( DW )} ( {b}_{{i}_{pruned}}^{( DW )} ) . \qquad ( Formula 5 )$$

Specific correction values will be described with reference to FIG. 3.

When neurons n1 and n2 are target neurons to be pruned, a first correction value for bias term 102 of neuron n11 is calculated by multiplication (convolution operation) of weight w2 and the bias value of bias term 101, and the bias value of bias term 102 after correction is the value obtained by adding the first correction value to the bias value of bias term 102 before correction. A second correction value for bias term 103 of neuron n12 is calculated by multiplication (convolution operation) of weight w3 and the bias value of bias term 101, and the bias value of bias term 103 after correction is the value obtained by adding the second correction value to the bias value of bias term 103 before correction. The bias term of each neuron in the PW convolutional layer is corrected in this way.

For example, neuron n3 illustrated in (b) in FIG. 3 is not a target neuron to be pruned. Hence, bias term correction of the PW convolutional layer using the bias term of neuron n3 is not performed.

Referring again to FIG. 2, corrector 22 then saves the learning model in which the bias term of each neuron in the PW convolutional layer has been corrected (S22). Corrector 22 stores the learning model in storage 30.

When the determination result in any of Steps S12, S14, and S16 is No, corrector 22 proceeds to after Step S21 in the processing of loop 1 and continues the processing of loop 1.

Although the above describes an example in which the bias of the subsequent convolutional layer (the PW convolutional layer in this embodiment) is generated when the subsequent convolutional layer does not have a bias term (S17: No), the present disclosure is not limited to this. For example, corrector 22 may proceed to Step S22 and the learning model with the bias term not corrected may be saved in storage 30.

Although the above describes an example in which correction values for all neurons are calculated in Step S20, only a correction value for each of one or more neurons as part of all neurons may be calculated. For example, only correction values for neurons whose weight is greater than or equal to a predetermined value may be calculated.

Model evaluator 12 may evaluate the learning model pruned as described above. Model creator 11 may perform relearning of the learning model pruned and corrected in bias terms.

### 3. Operation of Support Device

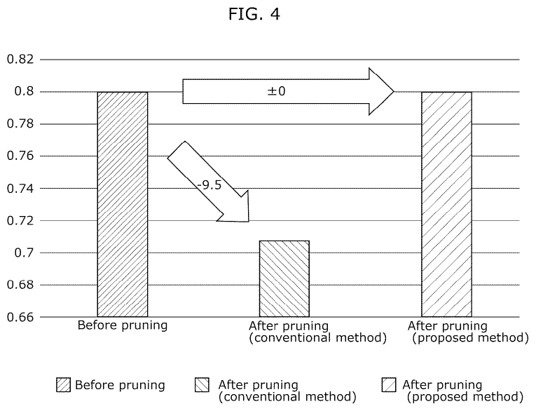

Next, the effects of support device 1 that executes the above-described support method will be described with reference to FIG. 4. FIG. 4 is a diagram for explaining the effects of support device 1 according to this embodiment.

FIG. 4 illustrates the results of comparison of learning model accuracy among before pruning, after pruning by a conventional method, and after pruning by the method proposed in the present disclosure. The number of prunings in the pruning process is the same.

As illustrated in FIG. 4, with the conventional method that does not involve bias term correction when pruning is performed, the accuracy decreases by 9.5%. With the proposed method according to the present disclosure that involves bias term correction when pruning is performed, degradation in accuracy caused by the bias term of the DW convolutional layer due to pruning can be suppressed, and approximately the same level of accuracy as before pruning can be maintained.

### Embodiment 2

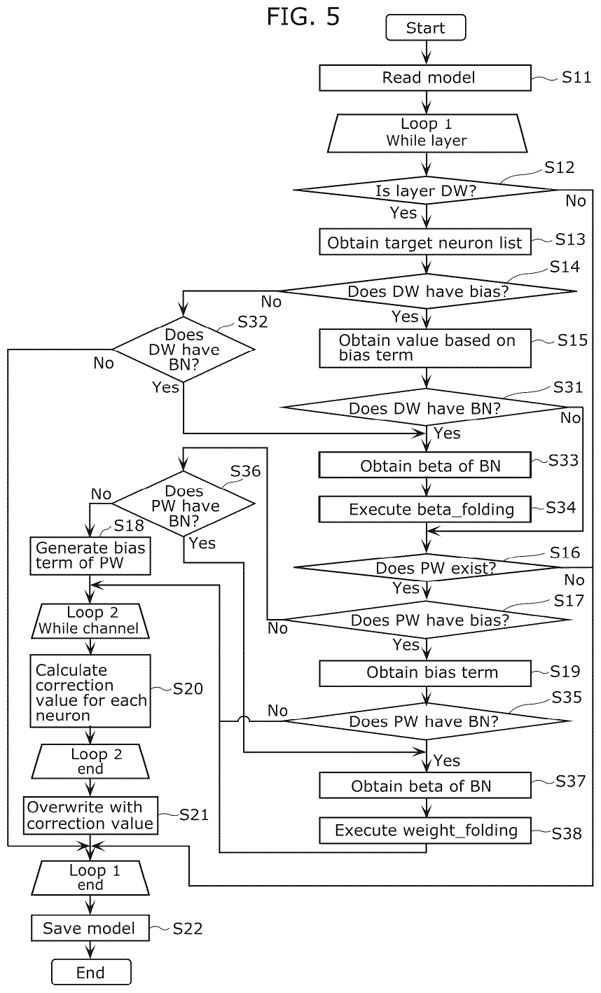

A support device according to this embodiment will be described below with reference to FIG. 5. The following will mainly describe the differences from Embodiment 1, while omitting or simplifying the description of the same or similar contents as Embodiment 1. Since the structure of the support device according to this embodiment is the same as that of support device 1 according to Embodiment 1, its description will be omitted. The reference signs for support device 1 according to Embodiment 1 will be used in the following description.

In this embodiment, a learning model includes a batch normalization (BN) layer subsequent to each of a DW convolutional layer and a PW convolutional layer. The batch normalization layer is provided to normalize the scale of the output result of each convolutional layer. Hereafter, the batch normalization layer is also referred to as “BN layer” or “BN”. The batch normalization layer is an example of a normalization layer.

The BN layer has a scale coefficient (γ) and an offset (beta) that are learned in the learning process by learner 10, as parameters. The scale coefficient is also referred to as “scale parameter”, and the offset is also referred to as “shift parameter”. The offset is a fixed value.

For example, the learning model includes a BN layer between the DW convolutional layer and the PW convolutional layer, and a BN layer between the PW convolutional layer and a convolutional layer subsequent to the PW convolutional layer. In other words, the DW convolutional layer and the PW convolutional layer are connected via a BN layer. For example, if the output from a preceding neuron is zero, the BN layer outputs a value of beta (beta value). An activation function may be applied depending on the learning model. Examples include, in the learning model, applying the activation function to the BN layer subsequent to the DW convolutional layer, applying the activation function to the DW convolutional layer and then connecting the BN layer, applying the activation function to the convolutional layer preceding the DW convolutional layer and then connecting the DW convolutional layer, and applying the activation function to the convolutional layer subsequent to the BN layer. In this embodiment, an example in which the activation function is applied to the BN layer subsequent to the DW convolutional layer will be described.

Although a batch normalization layer is taken as an example in this embodiment, the normalization layer used in the proposed method according to the present disclosure is not limited to a batch normalization layer. The normalization layer may be any other normalization layer having an offset parameter, such as a layer normalization layer or an instance normalization layer.

FIG. 5 is a flowchart illustrating the operation (support method) of support device 1 according to this embodiment.

As illustrated in FIG. 5, when corrector 22 determines that the DW convolutional layer does not have a bias (S14: No) or after Step S15, corrector 22 determines whether the DW convolutional layer has a BN layer based on the information about the learning model (S31, S32). Corrector 22 determines whether the layer subsequent to the DW convolutional layer is a BN layer based on the information about the learning model.

When corrector 22 determines that the layer subsequent to the DW convolutional layer is a BN layer (S31: Yes, S32: Yes), corrector 22 obtains the beta (beta value) of the BN layer (S33). For example, corrector 22 may obtain the beta of the BN layer by reading the beta stored in storage 30.

In this way, Step S33 may be executed regardless of the result of determination in Step S14. As another example, corrector 22 may obtain the beta only when the DW convolutional layer has a bias term and the DW convolutional layer has a BN layer.

Next, corrector 22 executes beta_folding (S34). Corrector 22 executes a filter process in the BN layer and converts the beta of the BN layer into a value that takes into account other parameters of the BN layer. For example, corrector 22 executes the filter process based on the following Formula 6, where β denotes a shift parameter (beta value), μ denotes a batch mean, γ denotes a scale parameter learned in the learning process by learner 10, σ denotes a batch variance, and eps denotes a small value to prevent division by zero. The value of eps is stored in storage 30 in advance, for example.

$$[ Math . 6 ]$$

$$Converted beta ( ) = {β}_{i} - \frac{{μ}_{i} \times {γ}_{i}}{\sqrt{{σ}_{i} + eps}} . \qquad ( Formula 6 )$$

The converted beta is used to calculate the correction value in Step S20.

Formula 6 is a formula when the output of the DW convolutional layer preceding the BN layer is zero. When the output of the DW convolutional layer preceding the BN layer is a bias value, the numerator of the second term on the right side of Formula 6 is the value obtained by multiplying, by the scale parameter, the result of subtracting the batch mean from the bias value. In other words, the BN layer outputs a value based on the bias term of the preceding DW convolutional layer to the PW convolutional layer subsequent to the BN layer.

In the case where a neuron in the DW convolutional layer or a connection between the DW convolutional layer and the BN layer is pruned, the value based on the bias term of the preceding DW convolutional layer, which is output from the BN layer, is used to calculate the correction value for the bias term in Step S20. Thus, even when the learning model includes a BN layer subsequent to the DW convolutional layer, the value based on the bias term of the DW convolutional layer connected to the target neuron to be pruned in the DW convolutional layer (the value based on the bias term and the converted beta in this example) is used to correct the bias term of each neuron in the PW convolutional layer.

When corrector 22 determines that the PW convolutional layer does not have a bias (S17: No) or after Step S19, corrector 22 determines whether the PW convolutional layer has a BN layer based on the information about the learning model (S35, S36). Corrector 22 determines whether the layer subsequent to the PW convolutional layer is a BN layer based on the information about the learning model.

When corrector 22 determines that the layer subsequent to the PW convolutional layer is a BN layer (S35: Yes, S36: Yes), corrector 22 obtains the beta (beta value) of the BN layer subsequent to the PW convolutional layer (S37). For example, corrector 22 may obtain the beta by reading the beta stored in storage 30.

In this way, Step S37 may be executed regardless of the result of determination in Step S17. As another example, corrector 22 may obtain the beta only when the PW convolutional layer has a bias term and the PW convolutional layer has a BN layer.

Next, corrector 22 executes weight_folding (S38). weight_folding is a process of correcting a weight (W_{bni} in the following Formula 7) between the PW convolutional layer and the BN layer subsequent to the PW convolutional layer, which is learned in the learning process by learner 10. Corrector 22 corrects the weight based on the following Formula 7, where Wᵢ is the weight of the PW convolutional layer and W_{bni} is the weight of the PW convolutional layer updated taking into account the BN layer.

$$[ Math . 7 ]$$

$${W}_{bni} = {W}_{i} \times \frac{{γ}_{i}}{\sqrt{{σ}_{i} + eps}} . \qquad ( Formula 7 )$$

Corrected weight W_{bni} is used to calculate the correction value in Step S20. When the BN layer is taken into account, the correction target is the beta (beta value) of the BN layer subsequent to the PW convolutional layer, and the following Formula 8 is used, for example.

$$[ Math . 8 ]$$

$$Corrected beta ( {β}_{j}^{( )} ) = {β}_{j}^{( PW )} + {W}_{{{bn}_{ji}}_{pruned}}^{( PW )} \cdot {f}^{( DW )} ( {\hat{β}}_{{i}_{pruned}}^{( DW )} ) . \qquad ( Formula 8 )$$

In Formula 8, the corrected beta (hatted β^{(DW)}) denotes the beta of the BN layer subsequent to the DW convolutional layer converted using Formula 6, W_{bnjipruned} denotes the weight of the PW convolutional layer corrected by the BN layer subsequent to the PW convolutional layer, β^{(PW)} denotes the beta of the BN layer subsequent to the PW convolutional layer, and the corrected beta denotes the beta of the BN layer subsequent to the PW convolutional layer.

Thus, in this embodiment, the correction value is calculated using the updated weight (W_{bni} in Formula 7) of the PW convolutional layer and the bias term of the DW convolutional layer. The correction value is used to correct the beta of the BN layer.

When the result of determination in Step S35 is No, the bias term of the PW convolutional layer is corrected using the following Formula 9 in Step S20.

$$[ Math . 9 ]$$

$$Corrected bias term ( {b}_{j}^{( )} ) = {b}_{j}^{( PW )} + {W}_{{ji}_{pruned}}^{( PW )} \cdot {f}^{( DW )} ( {\hat{β}}_{{i}_{pruned}}^{( DW )} ) . \qquad ( Formula 9 )$$

Next, corrector 22 overwrites the beta of the BN layer in the learning model learned by learner 10 with the correction value calculated in Step S20 (S21). The correction target here is the beta of the BN layer. Corrector 22 corrects the beta of the BN layer based on the correction value calculated in Step S20. In other words, corrector 22 replaces the beta of the BN layer with the beta corrected by the correction value.

When the result of determination in any of Steps S12, S16, and S32 is No, corrector 22 proceeds to after Step S21 in the processing of loop 1 and continues the processing of loop 1.

### Other Embodiments

While a support device, etc. according to one or more aspects have been described above by way of Embodiments 1 and 2, the present disclosure is not limited to Embodiments 1 and 2. Other modifications obtained by applying various changes conceivable by a person skilled in the art to the embodiments and any combinations of the elements in different embodiments without departing from the scope of the present disclosure are also included in the scope of the present disclosure.

For example, although Embodiments 1 and 2 describe an example in which the learning model includes one DW convolutional layer, the present disclosure is not limited to such, and the learning model may include a plurality of DW convolutional layers. For example, the learning model may include a plurality of DW convolutional layers arranged successively. When DW convolutional layers are successive, correction may be performed through a convolution operation with a subsequent convolutional layer (e.g. a PW convolutional layer) after the operation of the weights and biases of the successive DW convolutional layers is taken into account in advance. For example, the corrected bias term of the subsequent convolutional layer is expressed in the following Formula 10.

$$[ Math . 10 ]$$

$$Corrected bias term ( {b}_{j}^{( )} ) = {b}_{j}^{( PW )} + {W}_{{ji}_{pruned}}^{( PW )} \cdot {\sum }_{l = 1}^{L - 1} ( {\prod }_{m = l + 1}^{L} {W}_{{i}_{pruned}}^{( {DW}_{m} )} ) {b}_{{i}_{pruned}}^{( {DW}_{1} )} + {b}_{{i}_{pruned}}^{( {DW}_{L} )} . \qquad ( Formula 10 )$$

In Formula 10, L denotes the number of successive DW convolutional layers, W^{(DWm)} denotes the weight of the mth DW convolutional layer, and b^{(DWI)} denotes the bias term of the Ith DW convolutional layer. As shown in Formula 10, the operation of the weights and bias terms of the successive DW convolutional layers is performed in advance, and the resultant value and the weight of the subsequent convolutional layer are multiplied (convolution operation) to yield the correction value. The correction value and the bias term of the subsequent convolutional layer are added together to yield the corrected bias term. Weight W^{(PW)} is the weight between the last DW convolutional layer among the successive DW convolutional layers and the subsequent convolutional layer.

For example, suppose a first DW convolutional layer and a subsequent convolutional layer are connected via a second DW convolutional layer and one neuron in the first DW convolutional layer and one neuron in the second DW convolutional layer are connected via a target neuron to be pruned. Correction in such a case where two DW convolutional layers are arranged successively is performed as follows. A value obtained by multiplying (convolution operation) a second weight of the one neuron in the second DW convolutional layer by a first bias value of the one neuron in the first DW convolutional layer and a second bias value of the one neuron in the second DW convolutional layer are added together to yield a correction value. Specifically, the correction value is calculated by multiplying (convolution operation) the sum of the first bias value and the second bias value by the weight between the neurons. The second bias value is a value based on the bias term of the one neuron. The second bias value may be, for example, the bias term of the one neuron, or a value obtained by applying the activation function of the second DW convolutional layer to the bias term.

Operations corresponding to bias terms and parameters (beta after beta_folding) of BN layers can all be corrected in the same way as the operation in Formula 10.

Although Embodiments 1 and 2 describe an example in which the correction value is calculated based on the bias term and the weight, the present disclosure is not limited to such as long as the correction value is calculated based on at least the bias term. In other words, the correction value may be calculated without using the weight.

Each structural element in each of Embodiments 1 and 2 may be configured in the form of an exclusive hardware product, or may be implemented by executing a software program suitable for the structural element. Each structural element may be implemented by means of a program executing unit, such as a CPU or a processor, reading and executing the software program recorded on a recording medium such as a hard disk or semiconductor memory.

The order in which the steps are performed in each flowchart is an example provided for specifically describing the present disclosure, and order other than the above may be used. Part of the steps may be performed simultaneously (in parallel) with one or more other steps, and part of the steps may be omitted.

The division of the functional blocks in each block diagram is an example, and a plurality of functional blocks may be implemented as one functional block, one functional block may be divided into a plurality of functional blocks, or part of functions may be transferred to another functional block. Moreover, functions of a plurality of functional blocks having similar functions may be implemented by single hardware or software in parallel or in a time-sharing manner.

The support device according to each of Embodiments 1 and 2 may be implemented as a single device or a plurality of devices. In the case where the support device is implemented by a plurality of devices, the structural elements in the support device may be assigned to the plurality of devices in any way. In the case where the support device is implemented by a plurality of devices, the communication method between the plurality of devices is not limited, and may be wireless communication or wired communication. The communication method may be a combination of wireless communication or wired communication.

The structural elements described in each of Embodiments 1 and 2 may be implemented by software, and may be typically implemented by LSI which is an integrated circuit. The elements may each be individually implemented as one chip, or may be partly or wholly implemented on one chip. While description has been made regarding LSI, there are different names such as IC, system LSI, super LSI, and ultra LSI, depending on the degree of integration. The circuit integration technique is not limited to LSIs, and dedicated circuits (general-purpose circuits that execute dedicated programs) or general-purpose processors may be used to achieve the same. A field programmable gate array (FPGA) which can be programmed after manufacturing the LSI or a reconfigurable processor where circuit cell connections and settings within the LSI can be reconfigured may be used. Further, in the event of the advent of an integrated circuit technology which would replace LSIs by advance of semiconductor technology or a separate technology derived therefrom, such a technology may be used for integration of the elements.

A system LSI is a super-multifunctional LSI manufactured by integrating a plurality of processing units on a single chip, and specifically is a computer system including a microprocessor, ROM, RAM, and so forth. A computer program is stored in the ROM. The system LSI achieves its functions by the microprocessor operating according to the computer program.

One aspect of the present disclosure may be a computer program for causing a computer to execute each characteristic step included in the support method illustrated in any of FIGS. 2 and 5.

For example, the program may be a program to be executed by a computer. One aspect of the present disclosure may be a non-transitory computer-readable recording medium having such a program recorded thereon. For example, the program may be recorded on a recording medium and distributed or circulated. For example, by installing the distributed program in another device including a processor and causing the processor to execute the program, the processes can be performed by the device.

### Additional Note

The above description of each of Embodiments 1 and 2 discloses the following technologies.

### Technology 1

A support method of supporting pruning of a learning model using a neural network including a first depthwise convolutional layer and a subsequent convolutional layer subsequent to the first depthwise convolutional layer, the learning model including a target neuron to be pruned in the first depthwise convolutional layer, the support method including: determining whether the first depthwise convolutional layer has a bias term; obtaining a first bias value based on the bias term, when the first depthwise convolutional layer has the bias term; and calculating a correction value for correcting a bias term of the subsequent convolutional layer, using a value based on the first bias value.

In this way, the bias term of the subsequent convolutional layer is corrected based on the bias term to be pruned, with it being possible to suppress degradation in the accuracy of the learning model caused by the bias term to be pruned. Hence, when pruning the learning model, the learning model can be compressed (made more lightweight) without accuracy degradation.

### Technology 2

The support method according to technology 1, wherein the correction value is calculated based on the first bias value and a weight between the target neuron and a neuron in the subsequent convolutional layer.

In this way, the weight is taken into account in the calculation of the correction value, so that degradation in the accuracy of the learning model caused by the bias term to be pruned can be further suppressed.

### Technology 3

The support method according to technology 2, wherein the correction value is calculated by multiplying the first bias value and the weight.

In this way, it is possible to calculate, as the correction value, the value output to the subsequent convolutional layer when the input to the first depthwise convolutional layer is zero. Therefore, when the input to the first depthwise convolutional layer is zero or close to zero, a more appropriate correction value can be calculated. This leads to further suppressing degradation in the accuracy of the learning model.

### Technology 4

The support method according to any of technology 1 to technology 3, wherein the learning model further includes a normalization layer, the first depthwise convolutional layer and the subsequent convolutional layer are connected via the normalization layer, and the correction value is calculated based on the first bias value and a shift parameter of the normalization layer.

In this way, for a learning model that includes a normalization layer subsequent to the first depthwise convolutional layer, degradation in the accuracy of the learning model caused by the bias term to be pruned can be suppressed.

### Technology 5

The support method according to any of technology 1 to technology 4, wherein the learning model further includes a second depthwise convolutional layer, the first depthwise convolutional layer and the subsequent convolutional layer are connected via the second depthwise convolutional layer, one neuron in the first depthwise convolutional layer and one neuron in the second depthwise convolutional layer are connected, and the correction value is calculated by adding a second bias value of the one neuron in the second depthwise convolutional layer and a value obtained by multiplying the first bias value and a second weight of the one neuron in the second depthwise convolutional layer.

In this way, the bias term of the subsequent convolutional layer is corrected using the respective bias terms of the depthwise convolutional layers arranged successively. Thus, for that a learning model includes successive depthwise convolutional layers, degradation in the accuracy of the learning model caused by the bias term to be pruned can be suppressed.

### Technology 6

The support method according to any of technology 1 to technology 5, further including: correcting the bias term of the subsequent convolutional layer based on the correction value calculated; and saving the learning model having the bias term corrected.

In this way, the bias term correction process can be performed.

### Technology 7

The support method according to any of technology 1 to technology 6, wherein the subsequent convolutional layer is a pointwise convolutional layer.

In this way, for a learning model that includes a pointwise convolutional layer as the subsequent convolutional layer, degradation in the accuracy of the learning model caused by the bias term to be pruned can be suppressed.

### Technology 8

The support method according to any of technology 1 to technology 7, further including: determining whether the subsequent convolutional layer has the bias term, wherein the correction value is calculated when the subsequent convolutional layer has the bias term.

In this way, the amount of processing by the support device that executes the support method can be reduced.

### Technology 9

The support method according to any of technology 1 to technology 8, wherein the first bias value based on the bias term is calculated based on the bias term of the first depthwise convolutional layer and an activation function of the first depthwise convolutional layer.

In this way, the correction value can be calculated taking into account the activation function that each layer in a neural network typically has. Hence, a more accurate correction value can be calculated and the versatility of the support method can be improved.

### Technology 10

A support device that supports pruning of a learning model using a neural network including a depthwise convolutional layer and a subsequent convolutional layer subsequent to the depthwise convolutional layer, the learning model including a target neuron to be pruned in the depthwise convolutional layer, the support device including: a determiner that determines whether the depthwise convolutional layer has a bias term; an obtainer that obtains a bias value based on the bias term, when the depthwise convolutional layer has the bias term; and a calculator that calculates a correction value for correcting a bias term of the subsequent convolutional layer, using a value based on the bias value.

This has the same effects as the support method described above.

### Technology 11

A non-transitory computer-readable recording medium having recorded thereon a program for causing a computer to execute the support method according to any of technology 1 to technology 9.

This has the same effects as the support method described above.

These general and specific aspects may be implemented using a system, a method, an integrated circuit, a computer program, or a non-transitory computer-readable recording medium such as CD-ROM, or any combination of a system, a method, an integrated circuit, a computer program, and a recording medium. The program may be stored in the recording medium beforehand, or supplied to the recording medium via a wide area communication network such as the Internet.

While various embodiments have been described herein above, it is to be appreciated that various changes in form and detail may be made without departing from the spirit and scope of the present disclosure as presently or hereafter claimed.

### Further Information About Technical Background to This Application

The disclosure of the following patent application including specification, drawings, and claims are incorporated herein by reference in their entirety: Japanese Patent Application No. 2024-055974 filed on Mar. 29, 2024.

### INDUSTRIAL APPLICABILITY

The present disclosure is useful for an information processing device, etc. that perform pruning of a learning model.

1. A support method of supporting pruning of a learning model using a neural network including a first depthwise convolutional layer and a subsequent convolutional layer subsequent to the first depthwise convolutional layer, the learning model including a target neuron to be pruned in the first depthwise convolutional layer, the support method comprising:
determining whether the first depthwise convolutional layer has a bias term;
obtaining a first bias value based on the bias term, when the first depthwise convolutional layer has the bias term; and
calculating a correction value for correcting a bias term of the subsequent convolutional layer, using a value based on the first bias value.

2. The support method according to claim 1, wherein the correction value is calculated based on the first bias value and a weight between the target neuron and a neuron in the subsequent convolutional layer.

3. The support method according to claim 2, wherein the correction value is calculated by multiplying the first bias value and the weight.

4. The support method according to claim 1, wherein the learning model further includes a normalization layer,
the first depthwise convolutional layer and the subsequent convolutional layer are connected via the normalization layer, and
the correction value is calculated based on the first bias value and a shift parameter of the normalization layer.

5. The support method according to claim 1,
wherein the learning model further includes a second depthwise convolutional layer,
the first depthwise convolutional layer and the subsequent convolutional layer are connected via the second depthwise convolutional layer,
one neuron in the first depthwise convolutional layer and one neuron in the second depthwise convolutional layer are connected, and
the correction value is calculated by adding a second bias value of the one neuron in the second depthwise convolutional layer and a value obtained by multiplying the first bias value and a second weight of the one neuron in the second depthwise convolutional layer.

6. The support method according to claim 1, further comprising:
correcting the bias term of the subsequent convolutional layer based on the correction value calculated; and
saving the learning model having the bias term corrected.

7. The support method according to claim 1,
wherein the subsequent convolutional layer is a pointwise convolutional layer.

8. The support method according to claim 1, further comprising:
determining whether the subsequent convolutional layer has the bias term,
wherein the correction value is calculated when the subsequent convolutional layer has the bias term.

9. The support method according to claim 1,
wherein the first bias value based on the bias term is calculated based on the bias term of the first depthwise convolutional layer and an activation function of the first depthwise convolutional layer.

10. A support device that supports pruning of a learning model using a neural network including a depthwise convolutional layer and a subsequent convolutional layer subsequent to the depthwise convolutional layer, the learning model including a target neuron to be pruned in the depthwise convolutional layer, the support device comprising:
a determiner that determines whether the depthwise convolutional layer has a bias term;
an obtainer that obtains a bias value based on the bias term, when the depthwise convolutional layer has the bias term; and
a calculator that calculates a correction value for correcting a bias term of the subsequent convolutional layer, using a value based on the bias value.

11. A non-transitory computer-readable recording medium having recorded thereon a program for causing a computer to execute the support method according to claim 1.
